(19) United States
(12) Patent Application Publication
(10) Pub. No.: US 2019/0041839 A1
(43) Pub. Date: Feb. 7, 2019

(54) APPARATUS FOR TROUBLESHOOTING FAULT COMPONENT IN EQUIPMENT AND METHOD THEREOF

(71) Applicant: Hefei University of Technology, Hefei (CN)

(72) Inventors: Qiang ZHANG, Hefei (CN); Shanlin YANG, Hefei (CN); Wanying WANG, Hefei (CN); Zhanglin PENG, Hefei (CN); Xiaonong LU, Hefei (CN); Jun PEI, Hefei (CN)

(21) Appl. No.: 16/053,994

(22) Filed: Aug. 3, 2018

(30) Foreign Application Priority Data
Aug. 4, 2017 (CN) 201710661722.5

(51) Int. Cl. G05B 23/02

(52) U.S. Cl. CPC G05B 23/0262

(57) ABSTRACT

Disclosed is an apparatus for troubleshooting fault component in equipment and a method thereof. The device includes portions for building a fault-component-sensor Bayesian belief network model by acquiring component state-abnormal and data of fault maintenance of the equipment, and for calculating probabilities of actual component abnormality when a sensor connected with an component detects component abnormality based on the model; and arranging the probabilities in a descending order to obtain the arranged probabilities of actual component abnormality, and the top-arranged component being the one to be troubleshot first. Namely, a relational expression among the fault, the component and the sensor may be systematically built by adopting the method or the apparatus provided by the present disclosure, and the most-likely-failing component in an equipment may be quickly detected according to the expression, thereby improving troubleshooting efficiency.

### TECHNICAL FIELD

The present disclosure relates to the technical field of equipment maintenance, in particular to an apparatus for troubleshooting a fault component in an equipment and a method thereof.

### BACKGROUND

At present, most of hydraulic press equipment failures are troubleshot through human subjective judgments based on fault phenomena. This method tends to be restricted by human subjective consciousness and skills of technicians. In addition, troubleshooting is performed by experience, not in a certain order. Therefore, it tends to result in a waste of certain time and energy, thereby causing low efficiency of troubleshooting fault component in equipment. Therefore, how to improve the efficiency of troubleshooting fault component in equipment is a problem to be solved urgently in the technical field of equipment maintenance.

### SUMMARY

The objective of the present disclosure is to provide an apparatus for troubleshooting fault component in equipment and a method thereof. Data analysis is performed by using component-abnormal data and fault maintenance data which are detected by a sensor to obtain an component which is most likely to fail in an equipment fault, so as to assist in troubleshooting and improve the efficiency of troubleshooting fault component in equipment.

To achieve the above-mentioned objective, the present disclosure provides the following solution.

The present disclosure provides an apparatus for troubleshooting fault component in equipment, which includes:

an acquiring portion, configured to acquire data of the component in the abnormal state and data of fault maintenance of the equipment;

a building portion, configured to build a fault-component-sensor Bayesian belief network model according to the data of the component in the abnormal state and data of fault maintenance of the equipment, wherein the fault-component-sensor Bayesian belief network model includes: a sensor, an component and a set fault for the equipment; in the fault-component-sensor Bayesian belief network model, the sensor is connected with the component; the component is connected with the set fault for equipment; connection between the sensor and the component represents that the sensor detects whether the component is abnormal; and connection between the component and the set fault for equipment represents the set fault for equipment induced by component abnormality;

a calculating portion, configured to calculate probabilities of actual component abnormality when the sensor connected with the component detects that the component is abnormal according to the fault-component-sensor Bayesian belief network model; and

a ranking portion, configured to rank the probabilities of actual component abnormality when the sensor connected with the component detects that the component is abnormal in a descending order to obtain arranged probabilities of actual component abnormality, correspondingly arranging the components according to the sequence of the arranged probabilities of actual component abnormality, and the top-arranged component being the one to be troubleshot first.

Optionally, the building portion specifically includes:

a constructing unit, configured to construct a table of sensor abnormality-component according to the data of the component in the abnormal state, wherein the table of sensor abnormality-component includes probabilities of sensor detecting component abnormality and actual component abnormality; the data of the component in the abnormal state include the number of times of sensor detecting component abnormality and actual component abnormality, the number of times of sensor detecting component abnormality and actual component normality, and the number of times of sensor detecting component normality and actual component abnormality; the probabilities of sensor detecting component abnormality and actual component abnormality represents the ratio of the number of times of sensor detecting component abnormality and actual component abnormality to the number of times of actual component abnormality; the number of times of component abnormality represents the sum of the number sensor detecting component abnormality and actual component abnormality, the number of times of sensor detecting component abnormality and actual component normality, and the number of times of sensor detecting component normality and actual component abnormality;

a generating unit, configured to generate a fault dictionary according to the data of fault maintenance of the equipment, wherein the fault dictionary includes a first probability of each component; the first probability is a probability of each equipment set fault induced by component abnormality; the data of fault maintenance of the equipment include the number of times of each equipment set fault induced by the abnormality of each component; and the first probability represents a ratio of the number of times of the set fault for equipment induced by component abnormality to the sum of the number of times of the set fault for equipment induced by the abnormality of each component; and

a building unit, configured to build a fault-component-sensor Bayesian belief network model by adopting a Bayesian belief network according to the fault dictionary and the table of sensor abnormality-component.

Optionally, the calculating portion specifically includes:

a calculating unit, configured to calculate the probabilities of actual component abnormality when the sensor connected with the component detects that the component is abnormal according to the following formula:

$$\begin{matrix}\{ \begin{matrix}\begin{matrix}{P}_{1} = ( {E}_{i} = abnormal \vert & {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & ⋮ & & \\ {P}_{{2}^{m - 1}} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal )\end{matrix}\end{matrix} & ( 1 ) \\ {P}_{Ei} = {P}_{1} + {P}_{2} + … + {P}_{{2}^{m}} & \end{matrix}$$

where Ei represents the ith component; S represents the sensor; m represents the number of the sensors; PEi represents the probability that the component Ei is actually abnormal when the sensors with a number of m are connected with the component Ei detect that the component Ei is in an abnormal state.

Optionally, the apparatus further includes: an operating portion, configured to correct and inquiring the sequence of the components which are correspondingly arranged according to the sequence of the arranged probabilities of actual component abnormality.

Optionally, the apparatus further includes: a display portion, configured to display the sequence of the components which are correspondingly arranged according to the sequence of the arranged probabilities of actual component abnormality.

Optionally, the apparatus further includes: a sending portion, configured to send to a terminal the sequence of the components which are correspondingly arranged according to the sequence of the arranged probabilities of actual component abnormality.

Optionally, the apparatus further includes: a storage portion, configured to store the data of the component in the abnormal state, the data of fault maintenance of the equipment, the fault-component-sensor Bayesian belief network model, the sequence of the arranged probabilities of actual component abnormality and the sequence of the components which are correspondingly arranged according to the sequence of the arranged probabilities of actual component abnormality.

The present disclosure further provides a method for troubleshooting fault component in equipment, including:

acquiring data of the component in the abnormal state and data of fault maintenance of the equipment;

building a fault-component-sensor Bayesian belief network model according to the data of the component in the abnormal state and data of fault and maintenance of the equipment; wherein the fault-component-sensor Bayesian belief network model comprises a sensor, a component and a set fault for the equipment; in the fault-component-sensor Bayesian belief network model, the sensor is connected with the component; the component is connected with the set fault for the equipment; the connection between the sensor and the component involves whether the component detected by the sensor is abnormal; and the connection between the component and the set fault for equipment involves that the set fault for equipment is induced by an abnormality of the component;

calculating a plurality of probabilities of actual component abnormality detected by each of a plurality of sensors connecting with each of a plurality of components based on the fault-component-sensor Bayesian belief network model; and

ranking the plurality of probabilities of actual component abnormality detected by the plurality of sensors connecting with each of the plurality of the components in a descending order, and to obtain ranked probabilities that the plurality of components are actually abnormal; the plurality of the components are ranked correspondingly according to the plurality of the probabilities of actual component abnormality ranked; and a top-ranked component is to be troubleshot first.

Optionally, the step of building the fault-component-sensor Bayesian belief network model according to the data of the component in the abnormal state and data of fault maintenance of the equipment specifically includes:

constructing a table of sensor abnormality-component based on the data of the component in the abnormal state; wherein the table of sensor abnormality-component comprises a probability that a component is detected abnormal by the plurality of sensors and the component is actually abnormal; the data of the component in the abnormal state comprises a number of times that a component is detected abnormal by each of the plurality of sensors and the component is actually abnormal, a number of times that a component is detected normal by each of the plurality of sensors but the component is actually abnormal, and a number of times a component is detected normal by each of the plurality of sensors but the component is actually abnormal; wherein the probability that a component is detected abnormal by each of the plurality of sensors and the component is actually abnormal is represented by a ratio of a number of times a component is detected abnormal by each of the plurality of sensors and the component is actually abnormal, to a number of times of component abnormality; wherein the number of times of component abnormality is represented by a sum of the number of times that the component is detected abnormal by each of the plurality of sensors and the component is actually abnormal, the number of times that the component is detected normal by each of the plurality of sensors but the component is actually abnormal, and the number of times that the component is detected normal by each of the plurality of sensors but the component is actually abnormal;

generating a fault dictionary based on the data of fault maintenance of the equipment; wherein the fault dictionary comprises a first probability of each of the plurality of components; the first probability is a probability of the set fault of the equipment when each of the plurality of components is abnormal; the data of fault maintenance of the equipment comprises a number of times of the set fault of the equipment when each of the plurality of the components is abnormal; wherein the first probability is further represented by a ratio of the number of times of set fault of the equipment when each of the plurality of the components is abnormal to the sum of the number of times of the set fault of the equipment when each of the plurality of the components is abnormal; and

building a fault-component-sensor Bayesian belief network model with a Bayesian belief network based on the fault dictionary and the table of sensor abnormality-component.

Optionally, the step of calculating the probabilities of actual component abnormality when the sensor connected with the component detects that the component is abnormal according to the fault-component-sensor Bayesian belief network model specifically includes:

the plurality of probabilities of actual component abnormality detected by the plurality of sensors connecting with each of the plurality of the components according to the following formula:

$$\begin{matrix}\{ \begin{matrix}\begin{matrix}{P}_{1} = ( {E}_{i} = abnormal \vert & {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & ⋮ & & \\ {P}_{{2}^{m - 1}} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} & ( 1 )\end{matrix}$$

where Eᵢ represents the ith component; S represents the sensor; m represents the number of the sensors; P_{Ei} represents the probability that the component Eᵢ is actually abnormal when the m sensor connected with the component Eᵢ detect that the component Eᵢ is in an abnormal state.

Optionally, the method for troubleshooting fault component in equipment further includes:

calculating a probability of a set fault for the equipment induced by the abnormalities of the component connected with the set fault for equipment according to the fault-component-sensor Bayesian belief network model and a formula (2), wherein the formula (2) is as follows:

$$\begin{matrix}\{ \begin{matrix}\begin{matrix}{P}_{1} = ( {F}_{j} = abnormal \vert & {E}_{j 1} = abnormal , & {E}_{j 2} = normal , … , & {E}_{jn} = normal )\end{matrix} \\ \begin{matrix}{P}_{2} = ( {F}_{j} = abnormal \vert & {E}_{j 1} = abnormal , & {E}_{j 2} = abnormal , … , & {E}_{jn} = normal )\end{matrix} \\ \begin{matrix} & ⋮ & & \\ {P}_{{2}^{n - 1}} = ( {F}_{j} = abnormal \vert & {E}_{j 1} = normal , & {E}_{j 2} = abnormal , … , & {E}_{jn} = abnormal ) \\ {P}_{{2}^{n}} = ( {F}_{j} = abnormal \vert & {E}_{j 1} = abnormal , & {E}_{j 2} = abnormal , … , & {E}_{jn} = abnormal ) \\ {P}_{Fj} = {P}_{1} + {P}_{2} + … + {P}_{{2}^{n}} & & & \end{matrix}\end{matrix} & ( 2 )\end{matrix}$$

where Fⱼ represents the jth fault; E represents the component; n represents the number of the components; and P_{Fj} represents the probability of the set fault for equipment Fⱼ induced by the abnormalities of the n component connected with the set fault for equipment Fⱼ.

Optionally, before the step of arranging the probabilities of actual component abnormality when the sensor connected with the component detects that the component is abnormal in sequence in a descending order to obtain arranged probabilities of actual component abnormality, correspondingly arranging the components according to the sequence of the arranged probabilities of actual component abnormality, and the top-arranged component being the one to be troubleshot first, the method further includes:

judging whether the first probability of an component is greater than a first threshold value and whether the component is connected with each of the plurality of the sensor, obtaining a first judgment result;

connecting each of the plurality of sensors with the component, if the first judgment result shows that the first probability of the component is greater than the first threshold value and the component is not connected with each of the plurality of sensors;

maintaining connection between the component and the plurality of sensors, if the first judgment result shows that the first probability of the component is no larger than the first threshold value or the component is connected with the plurality of sensors;

updating the fault-component-sensor Bayesian belief network model based on the first judgment result; and

calculating the actual probability of component abnormality when the component is detected abnormal by the plurality of the sensor connecting to the component based on the updated fault-component-sensor Bayesian belief network model.

Optionally, the step of updating the fault-component-sensor Bayesian belief network model according to the first judgment result specifically includes:

judging whether the probability that a component is detected abnormal by each of the plurality of sensors and the component is actually abnormal is no smaller than a second threshold value, obtaining a second judgment result;

reserving the sensor if the second judgment result shows that the probability that a component is detected abnormal by each of the plurality of sensors connecting to the component and the component is actually abnormal is no smaller than the second threshold value;

judging whether the probability that a component is detected abnormal by each of the plurality of sensors connecting to the component and the component is actually abnormal is no smaller than a third threshold value, if the second judgment result shows the probability is less than the second threshold value when the component is detected abnormal, and obtaining a third judgment result; wherein the third threshold value is represented by a setting number of times of the probability when the plurality of sensors connected with the component except for the sensor detected that the component is abnormal and the component is actually abnormal;

reserving the sensor if the third judgment result shows that the probability that the component is actually abnormal when the sensor connected with the component detects that the component is in the abnormal state is no smaller than the third threshold value;

removing the sensor if the third judgment result shows that the actual probability of component abnormality is less than the third threshold value when the component is detected abnormal by the sensor; and

updating the fault-component-sensor Bayesian belief network model according to the first judgment result, the second judgment result and the third judgment result.

Optionally, the method for troubleshooting fault component in equipment further includes:

calculating the probabilities of the set fault for the equipment induced by the abnormality of the component connected with the updated equipment set fault according to the updated fault-component-sensor Bayesian belief network model; and

building an equipment risk early-warning database according to the calculated probabilities of the set fault for equipment induced by the abnormality of the component connected with the updated set fault for the equipment.

According to the specific embodiments provided by the present disclosure, the present disclosure discloses the following technical effects:

The present disclosure provides an apparatus for troubleshooting fault component in equipment and a method thereof which are implemented by acquiring the data of the component in the abnormal state and the data of fault maintenance of the equipment, building the fault-component-sensor Bayesian belief network model according to the data, calculating the probabilities of actual component abnormality when the sensor connected with the component detects that the component is abnormal based on the fault-component-sensor Bayesian belief network model, arranging the probabilities of actual component abnormality when the sensor connected with the component detects that the component is abnormal in a descending order to obtain arranged probabilities of actual component abnormality, correspondingly arranging the components according to the sequence of the arranged probabilities of actual component abnormality, and the top-arranged component being the one to be troubleshot first. Namely, a relational expression among the fault, the component and the sensor may be systematically built by adopting the method or the apparatus provided by the present disclosure, and the most-likely-failing component in an equipment may be quickly detected according to the relational expression, thereby avoiding human subjective troubleshooting and improving efficiency of troubleshooting fault component in equipment. In addition, the present disclosure judges whether the sensor is required to be added into or removed from the fault-component-sensor Bayesian belief network model according to the calculated probabilities of actual component abnormality when the sensor connected with the component detects that the component is abnormal and the probabilities of the set fault for equipment induced by the abnormalities of the component connected with the set fault for equipment, and updates the fault-component-sensor Bayesian belief network model according to the judgment results to improve the accuracy of the relational expression among the fault, the component and the sensor, thereby calculating the probabilities of actual component abnormality when the sensor connected with the component detects that the component is abnormal on the basis of the updated fault-component-sensor Bayesian belief network model to improve the accuracy of troubleshooting fault component in equipment.

Therefore, through the adoption of the apparatus for troubleshooting fault component in equipment and the method thereof provided by the present disclosure, not only the efficiency but also the accuracy of troubleshooting fault component in equipment is improved.

### BRIEF DESCRIPTION OF THE DRAWINGS

To describe embodiments of the present disclosure or technical solutions in the prior art more clearly, drawings to be used in the embodiments will be briefly introduced below. Apparently, the drawings in the descriptions below are only some embodiments of the present disclosure. Those ordinary skilled in the art can also obtain other drawings according to these drawings without contributing creative work.

FIG. 1 is a structural schematic diagram of the apparatus for troubleshooting fault component in equipment according to an embodiment of the present disclosure;

FIG. 2 is a flow chart I of the method for troubleshooting fault component in equipment according to an embodiment of the present disclosure;

FIG. 3 is a flow chart II of the method for troubleshooting fault component in equipment according to an embodiment of the present disclosure; and

FIG. 4 is a structural schematic diagram of a fault-component-sensor Bayesian belief network model according to an embodiment of the present disclosure.

### DETAILED DESCRIPTION

Technical solutions in embodiments of the present disclosure will be described clearly and completely below in combination with the drawings in the embodiments of the present disclosure. Apparently, the embodiments described herein are only part of the embodiments of the present disclosure. Based on the embodiments in the present disclosure, all other embodiments acquired by people having ordinary skill in the art without contributing creative work shall fall into the protection scope of the present disclosure.

The objective of the present disclosure is to provide an apparatus for troubleshooting fault component in equipment and a method thereof. Data analysis is performed by using component-abnormal data and fault maintenance data which are detected by sensor to obtain an component which is most likely to fail in an equipment fault, so as to assist in troubleshooting and improve the efficiency of troubleshooting fault component in equipment.

fault dictionary: The fault dictionary refers to that all fault modes of equipment and feature information thereof are listed like a dictionary, or fault diagnosis experiences are symmetrically summarized and reflected in the form of table. It may be only a simple description relation between the fault modes and fault features, and also may be a complicated nonlinear relation between the fault modes of the equipment and feature vectors thereof, and further may be a fuzzy relation among expected feature vectors of the fault modes of the equipment. Due to the advantages of simplicity in calculation, definite relations and applicability to linear and nonlinear systems, a diagnosis technology based on the fault dictionary is very suitable for fault diagnosis and knowledge prediction of the equipment.

Bayesian belief network: It is called as Bayesian network for short, configured to graphically express relations among a group of random variables.

To make the above-mentioned objectives, features and advantages of the present disclosure more obvious and understandable, the present disclosure will be further described in detail below in combination with the drawings and specific implementation modes.

### Embodiment 1

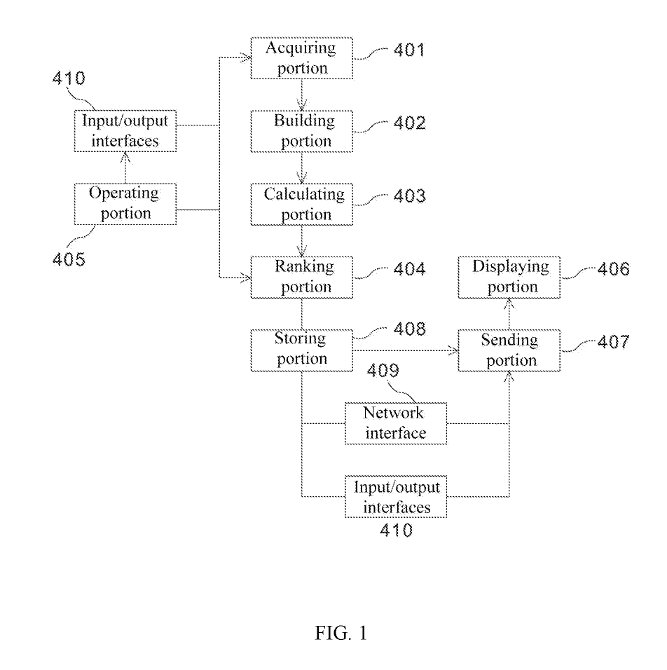

FIG. 1 is a structural schematic diagram of the apparatus for troubleshooting fault component in equipment according to an embodiment of the present disclosure. As shown in FIG. 1, the apparatus for troubleshooting fault component in equipment includes:

an acquiring portion 401, configured to acquire data of the component in the abnormal state and data of fault maintenance of the equipment, wherein the acquiring portion 401 includes sensor or manually input information;

a building portion 402, configured to build a fault-component-sensor Bayesian belief network model according to the data of the component in the abnormal state and data of fault maintenance of the equipment, wherein the fault-component-sensor Bayesian belief network model includes: a sensor, an component and a set fault for the equipment; in the fault-component-sensor Bayesian belief network model, the sensor is connected with the component; the component is connected with the set fault for equipment; connection between the sensor and the component represents that the sensor detect whether the component is abnormal; connection between the component and the set fault for equipment represents the set fault for equipment induced by component abnormality; the building portion 402 includes one or more central processing units (CPU) or other special processing units;

a calculating portion 403, configured to calculate probabilities of actual component abnormality when the sensor connected with the component detects that the component is abnormal according to the fault-component-sensor Bayesian belief network model, wherein the calculating portion 403 includes one or more CPUs or other special processing units; and

a ranking portion 404, configured to rank the probabilities of actual component abnormality when the sensor connected with the component detects that the component is abnormal in a descending order to obtain arranged probabilities of actual component abnormality, correspondingly arranging the components according to the sequence of the arranged probabilities of actual component abnormality, and the top-arranged component being the one to be troubleshot first, wherein the ranking portion 404 includes one or more CPUs or other special processing units.

The building portion 402 specifically includes:

a constructing unit, configured to construct a table of sensor abnormality-component according to the data of the component in the abnormal state, wherein the table of sensor abnormality-component comprises probabilities of sensor detecting component abnormality and actual component abnormality; the data of the component in the abnormal state comprise the number of times of sensor detecting component abnormality and actual component abnormality, the number of times of sensor detecting component abnormality and actual component normality and the number of times of sensor detecting component normality and actual component abnormality; the probabilities of sensor detecting component abnormality and actual component abnormality represents the ratio of the number of times of sensor detecting component abnormality and actual component abnormality to the number of times of actual component abnormality; the number of times of component abnormality represents the sum of the number of times of sensor detecting component abnormality and actual component abnormality, the number of times of sensor detecting component abnormality and actual component normality, and the number of times of sensor detecting component normality and actual component abnormality;

a generating unit, configured to generate a fault dictionary according to the data of fault maintenance of the equipment, wherein the fault dictionary includes a first probability of each component; the first probability is a probability of each equipment set fault induced by component abnormality; the data of fault maintenance of the equipment include the number of times of each equipment set fault induced by abnormality of each component; the first probability represents a ratio of the number of times of the set fault for equipment induced by the abnormalities of the component to the sum of the number of times of the set fault for equipment induced by the abnormality of each component; and

a building unit, configured to build a fault-component-sensor Bayesian belief network model by adopting the Bayesian belief network according to the fault dictionary and the table of sensor abnormality-component.

The calculating portion 403 specifically includes:

a calculating unit, configured to calculate the probabilities of actual component abnormality when the sensor connected with the component detects that the component is abnormal according to the following formula:

$$\begin{matrix}\{ \begin{matrix}\begin{matrix}{P}_{1} = ( {E}_{i} = abnormal \vert & {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & ⋮ & & \\ {P}_{{2}^{m - 1}} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} & ( 1 )\end{matrix}$$

where Eᵢ represents the ith component; S represents the sensor; m represents the number of the sensors; P_{Ei} represents the probability that the component Eᵢ is actually abnormal when the m sensor connected with the component Eᵢ detect that the component Eᵢ is in an abnormal state.

Preferably, the apparatus for troubleshooting fault component in equipment further includes: an operating portion 405, configured to correct and inquiring the sequence of the components which are correspondingly arranged according to the sequence of the arranged probabilities of actual component abnormality. The operating portion 405 is specifically a keyboard or a touch screen or a mouse.

Preferably, the apparatus for troubleshooting fault component in equipment further includes: a display portion 406, configured to display the sequence of the components which are correspondingly arranged according to the sequence of the arranged probabilities of actual component abnormality. The display portion 406 is specifically a display screen or a printing equipment.

Preferably, the apparatus for troubleshooting fault component in equipment further includes: a sending portion 407, configured to send to a terminal the sequence of the components which are correspondingly arranged according to the sequence of the arranged probabilities of actual component abnormality. The sending portion 407 is specifically a data wire, a Bluetooth unit or a WIFI wireless network transmission unit or a wired network transmission unit or a 2.5G, 3G, 4G and 5G transmission units.

Preferably, the apparatus for troubleshooting fault component in equipment further includes: a storage portion 408, configured to store the data of the component in the abnormal state, the data of fault maintenance of the equipment, the fault-component-sensor Bayesian belief network model, the sequence of the arranged probabilities of actual component abnormality and the sequence of the components which are correspondingly arranged according to the sequence of the arranged probabilities of actual component abnormality. The storage portion 408 is specifically a readable storage medium, such as a floppy disk of a computer, a USB disk, a mobile hard disk, a read-only memory (ROM), a random access memory (RAM), a magnetic disk or an optical disk and the like.

The apparatus for troubleshooting fault component in equipment further includes one or more wired or wireless network interfaces 409, one or more input/output interfaces 410, and one or more operating systems, such as Windows Server™, Mac OS X™, Unix™, Linux™, FreeBSD™, etc.

Through the descriptions of the above implementation modes, those skilled in the art can clearly know that the present disclosure may be realized by means of software and necessary universal hardware, and of course, may be also realized by means of special hardware including a special integrated circuit, a special CPU, a special memory, a special component and the like. In general, functions that are completed by a computer program may be realized easily by corresponding hardware. Moreover, a variety of specific hardware structures, such as an analog circuit, a digital circuit or a special circuit and the like, may be configured to realize the same function. However, it is the most preferable implementation mode to realize the functions by software programs for the present disclosure in most cases. Based on such an understanding, essential parts or parts that make contributions to the prior art in the technical solutions of the present disclosure may be embodied in the form of software products. The computer software products are stored in the readable storage medium, such as the floppy disk of the computer, the USB disk, the mobile hard disk, the ROM, the RAM, the magnetic disk or the optical disk, and include several instructions that enable a computer equipment (which may be a personal computer, a server, or a network equipment and the like) to execute the methods of all the embodiments of the present disclosure.

### Embodiment 2

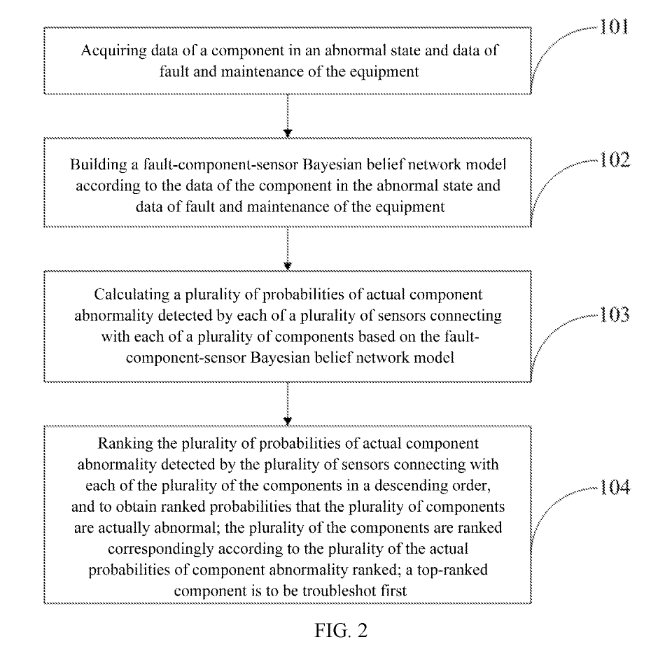

FIG. 2 is a flow chart I of a method for troubleshooting fault component in equipment according to an embodiment of the present disclosure. As shown in FIG. 2, the method for troubleshooting fault component in equipment provided by the present disclosure specifically includes the following steps:

Step 101: acquiring data of the component in the abnormal state and data of fault maintenance of the equipment;

Step 102: building a fault-component-sensor Bayesian belief network model according to the data of the component in the abnormal state and data of fault and maintenance of the equipment, wherein the fault-component-sensor Bayesian belief network model includes: a sensor, an component and a set fault for the equipment; in the fault-component-sensor Bayesian belief network model, the sensor is connected with the component; the component is connected with the set fault for equipment; connection between the sensor and the component represents that the sensor detects whether the component is abnormal; and connection between the component and the set fault for equipment represents equipment set fault induced by component abnormality;

Step 103: calculating a plurality of probabilities of actual component abnormality detected by each of a plurality of sensors connecting with each of a plurality of components based on the fault-component-sensor Bayesian belief network model; and

Step 104: ranking the plurality of probabilities of actual component abnormality detected by the plurality of sensors connecting with each of the plurality of the components in a descending order, and to obtain ranked probabilities that the plurality of components are actually abnormal; the plurality of the components are ranked correspondingly according to the plurality of the actual probabilities of component abnormality ranked; a top-ranked component is to be troubleshot first.

Step 102 specifically includes that:

constructing a table of sensor abnormality-component based on the data of the component in the abnormal state; wherein the table of sensor abnormality-component comprises a probability that a component is detected abnormal by the plurality of sensors and the component is actually abnormal; the data of the component in the abnormal state comprises a number of times that a component is detected abnormal by each of the plurality of sensors and the component is actually abnormal, a number of times that a component is detected normal by each of the plurality of sensors but the component is actually abnormal, and a number of times a component is detected normal by each of the plurality of sensors but the component is actually abnormal; wherein the probability that a component is detected abnormal by each of the plurality of sensors and the component is actually abnormal is represented by a ratio of a number of times a component is detected abnormal by each of the plurality of sensors and the component is actually abnormal, to a number of times of component abnormality; wherein the number of times of component abnormality is represented by a sum of the number of times that the component is detected abnormal by each of the plurality of sensors and the component is actually abnormal, the number of times that the component is detected normal by each of the plurality of sensors but the component is actually abnormal, and the number of times that the component is detected normal by each of the plurality of sensors but the component is actually abnormal;

generating a fault dictionary based on the data of fault maintenance of the equipment; wherein the fault dictionary comprises a first probability of each of the plurality of components; the first probability is a probability of the set fault of the equipment when each of the plurality of components is abnormal; the data of fault maintenance of the equipment comprises a number of times of the set fault of the equipment when each of the plurality of the components is abnormal; wherein the first probability is further represented by a ratio of the number of times of set fault of the equipment when each of the plurality of the components is abnormal to the sum of the number of times of the set fault of the equipment when each of the plurality of the components is abnormal; and

building a fault-component-sensor Bayesian belief network model with a Bayesian belief network based on the fault dictionary and the table of sensor abnormality-component.

Step 103 specifically includes:

calculating the plurality of probabilities of actual component abnormality detected by the plurality of sensors connecting with each of the plurality of the components according to the following formula:

$$\begin{matrix}\{ \begin{matrix}\begin{matrix}{P}_{1} = ( {E}_{i} = abnormal \vert & {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & ⋮ & & \\ {P}_{{2}^{m - 1}} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} & ( 1 )\end{matrix}$$

where Eᵢ represents the ith component; S represents the sensor; m represents the number of the sensors; P_{Ei} represents the probability that the component Eᵢ is actually abnormal when the m sensor connected with the component Eᵢ detect that the component Eᵢ is in an abnormal state.

### Embodiment 3

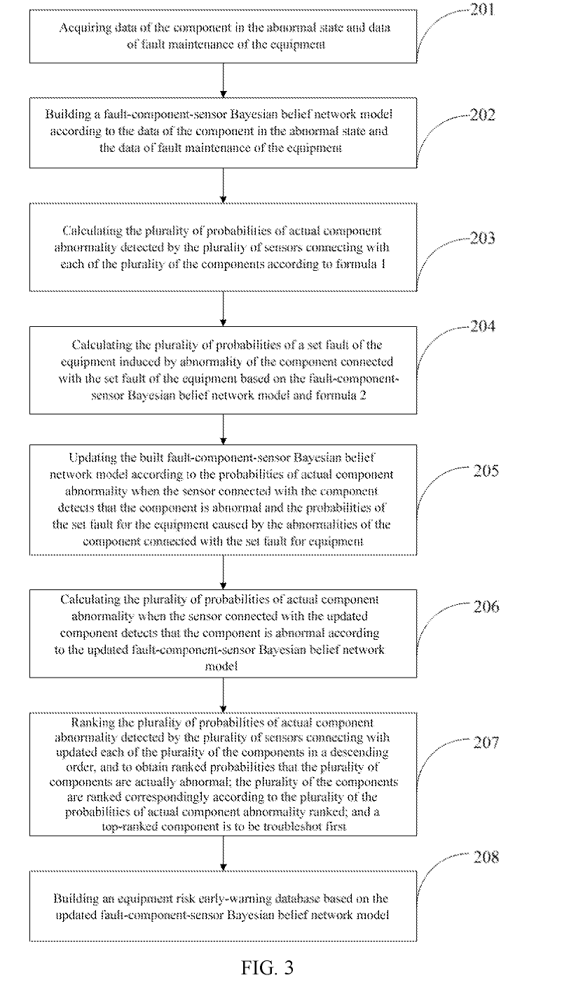

FIG. 3 is a flow chart II of a method for troubleshooting fault component in equipment according to an embodiment of the present disclosure. As shown in FIG. 3, the method for troubleshooting fault component in equipment provided by the present disclosure specifically includes the following steps:

step 201: acquiring data of the component in the abnormal state and data of fault maintenance of the equipment;

step 202: building a fault-component-sensor Bayesian belief network model according to the data of the component in the abnormal state and the data of fault maintenance of the equipment, wherein the fault-component-sensor Bayesian belief network model includes: a sensor, an component and a set fault for the equipment; in the fault-component-sensor Bayesian belief network model, the sensor is connected with the component; the component is connected with the set fault for equipment; connection between the sensor and the component represents that the sensor detects whether the component is abnormal; and connection between the component and the set fault for equipment represents equipment set fault induced by component abnormality.

step 202 specifically includes:

constructing a table of sensor abnormality-component according to the data of the component in the abnormal state, wherein the table of sensor abnormality-component, as shown in Table 1, includes multiple Rⱼᵢs; Rⱼᵢ represents the probability that the ith sensor detects that the jth component is abnormal and the nth component is actually abnormal; the data of the component in the abnormal state include the number of times that the sensor detects that the component is abnormal and the component is actually abnormal, the number of times that the sensor detects that the component is abnormal and the component is actually normal, and the number of times that the sensor detects that the component is normal and the component is actually abnormal; the probabilities that the sensor detects that the component is abnormal and the component is actually abnormal represent ratios of the number of times that the sensor detects that the component is abnormal and the component is actually abnormal to the number of times that the component is abnormal; the number of times that the component is abnormal represents the sum of the number of times that the sensor detects that the component is abnormal and the component is actually abnormal, the number of times that the sensor detects that the component is abnormal and the component is actually normal, and the number of times that the sensor detects that the component is normal and the component is actually abnormal.

TABLE 1
Table of sensor abnormality-component

Sensor

| Component | S₁ | S₂ | . . . | Sₘ |
|---|---|---|---|---|
| E₁ | R₁₁ | R₁₂ | . . . | R₁ₘ |
| E₂ | R₂₁ | R₂₂ | . . . | R₂ₘ |
| . . . | . . . | . . . | . . . | . . . |
| Eₙ | Rₙ₁ | Rₙ₂ | . . . | Rₙₘ |

A fault dictionary is generated according to the data of fault maintenance of the equipment, wherein the fault dictionary includes a first probability of each component; the first probability is a probability that the abnormality of the component causes each equipment set fault; the data of fault maintenance of the equipment, as shown in Table 2, include the number of times of each equipment set fault induced by abnormality of each component; and the first probability represents a ratio of the number of times of the set fault for equipment induced by the abnormalities of the component to the sum of the number of times of the set fault for equipment induced by the abnormality of each component.

TABLE 2
Data of fault maintenance of the equipment Table

| | |
|---|---|
| Set fault for the | Component |

| equipment | E₁ | E₂ | . . . | Eₙ | In total |
|---|---|---|---|---|---|
| F₁ | V₁₁ | V₁₂ | . . . | V₁ₘ | C₁ |
| F₂ | V₂₁ | V₂₂ | . . . | V₂ₘ | C₂ |
| . . . | . . . | . . . | . . . | . . . | . . . |
| F_{d} | V_{d1} | V_{d2} | . . . | V_{dn} | C_{d} |
| In total | V₁ | V₂ | | Vₙ | |

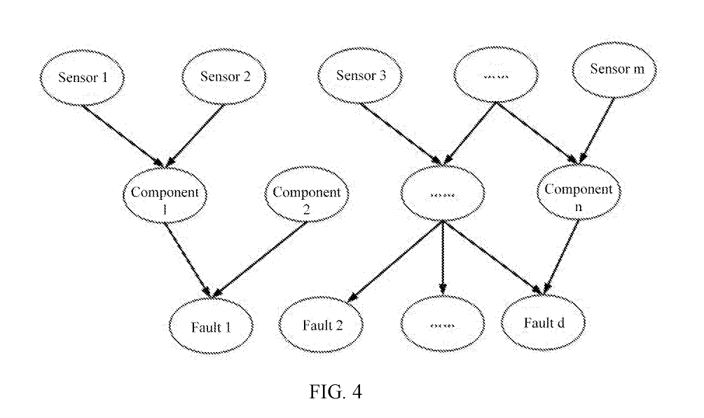

FIG. 4 is a structural schematic diagram of a fault-component-sensor Bayesian belief network model according to an embodiment of the present disclosure. As shown in FIG. 4, the fault-component-sensor Bayesian belief network model is built by adopting a Bayesian belief network according to the fault dictionary and the table of sensor abnormality-component. A specific algorithm of building the fault-component-sensor Bayesian belief network model includes:

Drawing an arc between a sensor and an component under the condition of Rₙₘ≠0;

Supposing that T=(F₁, F₂, . . . , F_{d}) is a total order of fault phenomena;

For j=1 to d do;

Setting that F_{T(j)} represents the jth fault phenomenon with the highest order in T;

Setting that π (F_{T(j)})={F_{T(1)}, F_{T(2)}, . . . , F_{T(j-1)}} represents a set of fault component arranged in front of F_{T(j)};

Removing the fault component which has no influence on Fⱼ from π (F_{T(j)}) (with prior knowledge);

Drawing arcs between the residual fault phenomena and the residual fault component in F_{T(j)} and π (F_{T(j)});

End for.

Step 203: calculating the plurality of probabilities of actual component abnormality detected by the plurality of sensors connecting with each of the plurality of the components according to formula 1, wherein the formula 1 is as follows:

$$\begin{matrix}\{ \begin{matrix}\begin{matrix}{P}_{1} = ( {E}_{i} = abnormal \vert & {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & ⋮ & & \\ {P}_{{2}^{m - 1}} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} & ( 1 )\end{matrix}$$

where Eᵢ represents the ith component; S represents the sensor; m represents the number of the sensors; P_{Ei} represents the probability that the component Eᵢ is actually abnormal when the m sensor connected with the component Eᵢ detect that the component Eᵢ is in an abnormal state. Namely, P_{Ei} represents a sum of 2^{m} probabilities;

Step 204: calculating the plurality of probabilities of a set fault of the equipment induced by abnormality of the component connected with the set fault of the equipment based on the fault-component-sensor Bayesian belief network model and formula 2, wherein the formula (2) is as follows:

$$\begin{matrix}\{ \begin{matrix}\begin{matrix}{P}_{1} = ( {F}_{j} = abnormal \vert & {E}_{j 1} = abnormal , & {E}_{j 2} = normal , … , & {E}_{jn} = normal )\end{matrix} \\ \begin{matrix}{P}_{2} = ( {F}_{j} = abnormal \vert & {E}_{j 1} = abnormal , & {E}_{j 2} = abnormal , … , & {E}_{jn} = normal )\end{matrix} \\ \begin{matrix} & ⋮ & & \\ {P}_{{2}^{n - 1}} = ( {F}_{j} = abnormal \vert & {E}_{j 1} = normal , & {E}_{j 2} = abnormal , … , & {E}_{jn} = abnormal ) \\ {P}_{{2}^{n}} = ( {F}_{j} = abnormal \vert & {E}_{j 1} = abnormal , & {E}_{j 2} = abnormal , … , & {E}_{jn} = abnormal ) \\ {P}_{Fj} = {P}_{1} + {P}_{2} + … + {P}_{{2}^{n}} & & & \end{matrix}\end{matrix} & ( 2 )\end{matrix}$$

where Fⱼ represents the jth fault; E represents the component; n represents the number of the components; and P_{Fj} represents the probability of the set fault for equipment Fⱼ induced by the abnormalities of the n component connected with the set fault for equipment Fⱼ. Namely, P_{Fj} represents a sum of 2ⁿ probabilities.

Step 205: updating the built fault-component-sensor Bayesian belief network model according to the probabilities of actual component abnormality when the sensor connected with the component detects that the component is abnormal and the probabilities of the set fault for equipment induced by the abnormalities of the component connected with the set fault for equipment.

Step 205 specifically includes:

Step 2051: judging whether the first probability of an component is greater than a first threshold value and whether the component is not connected with sensor, thereby obtaining a first judgment result;

Step 2052: connecting the sensor to the component if the first judgment result shows that the first probability of the component is greater than the first threshold value and the component is not connected with the sensor;

Step 2053: maintaining the connection relation between the component and the sensor if the first judgment result shows that the first probability of the component is less than or equal to the first threshold value or the component is connected with the sensor.

A specific algorithm of Steps 2051 to 2053 is as follows: the first threshold value in the embodiment of the present disclosure is 0.3;

For i=1 to do;

For J=1 to do;

If P (fault phenomenon=abnormal|component Eᵢⱼ=abnormal, component E_{i*}=normal (*≠j))>0.3;

If component Eᵢⱼ is qualified to monitor the abnormal state, but a sensor apparatus component is not set as a key component, then sensor configuration is updated, so as to configure a sensor for the component;

Else not updating the sensor configuration;

End if;

End if;

End for;

End for;

Step 2054: judging whether the probability that the sensor detects that an component is abnormal and the component is actually abnormal is greater than or equal to a second threshold value, thereby obtaining a second judgment result;

Step 2055: reserving the sensor if the second judgment result shows that the probability that the sensor detects that the component is abnormal and the component is actually abnormal is greater than or equal to the second threshold value;

Step 2056: judging whether the probability that the component is actually abnormal when the sensor connected with the component detects that the component is in an abnormal state is greater than or equal to a third threshold value if the second judgment result shows that the probability that the sensor detects that the component is abnormal and the component is actually abnormal is less than the second threshold value, thereby obtaining a third judgment result, wherein the third threshold value represents a set multiple of the probability that only the sensor connected with the component detects that the component is abnormal and the component is actually abnormal;

Step 2057: reserving the sensor if the third judgment result shows that the probability that the component is actually abnormal when the sensor connected with the component detects that the component is in the abnormal state is greater than or equal to the third threshold value;

Step 2058: removing the sensor if the third judgment result shows that the probability that the component is actually abnormal when the sensor connected with the component detects that the component is in the abnormal state is less than the third threshold value;

Step 2059: updating the fault-component-sensor Bayesian belief network model according to the first judgment result, the second judgment result and the third judgment result;

A specific algorithm of Steps 2054 to 2059 is as follow: the second threshold value in the embodiment of the present disclosure is 0.3, and the multiple is set as 1.105;

For i=1 to do;

For J=1 to do;

If the probability that the component detected by only using the sensor is abnormal is Rᵢⱼ<0.3;

If a sensor does not belong to redundant sensor when P (component=abnormal|information of other sensors+information of the sensor)−P (component=abnormal|other sensors)≥0.105;

Else the sensor is the redundant sensor;

End if;

End if;

End for;

End for;

Step 2057: updating the fault-component-sensor Bayesian belief network model according to the first judgment result and the second judgment result.

Step 206: calculating the probabilities of actual component abnormality when the sensor connected with the updated component detects that the component is abnormal according to the updated fault-component-sensor Bayesian belief network model;

Step 207: Ranking the plurality of probabilities of actual component abnormality detected by the plurality of sensors connecting with updated each of the plurality of the components in a descending order, and to obtain ranked probabilities that the plurality of components are actually abnormal; the plurality of the components are ranked correspondingly according to the plurality of the probabilities of actual component abnormality ranked; and a top-ranked component is to be troubleshot first; and

Step 208: building an equipment risk early-warning database based on the updated fault-component-sensor Bayesian belief network model.

Step 208 specifically includes that:

calculating the probabilities of the set fault for equipment induced by the abnormalities of the component connected with the updated equipment set fault; and

building the equipment risk early-warning database according to the calculated probabilities of the set fault for equipment induced by the abnormalities of the component connected with the updated equipment set fault.

The equipment risk early-warning database includes third-level risk early-warning, second-level risk early-warning and first-level risk early-warning. The third-level risk early-warning is provided when the probability of a set fault for the equipment induced by the abnormality of an component connected with the updated equipment set fault is more than 0.3. The second-level risk early-warning is provided when the probability of a set fault for the equipment induced by the abnormality of an component connected with the updated equipment set fault is more than 0.6. The first-level risk early-warning is provided when the probability of a set fault for the equipment induced by the abnormality of an component connected with the updated equipment set fault is more than 0.9.

A specific algorithm of Step 208 is as follows:

inputting: data D=(S₁, S₂, . . . , S*) monitored by the plurality of sensors; processing the data monitored by the plurality of sensors one by one in real time;

X0=(T₁, T₂, . . . , Tⱼ), wherein T*=normal

Setting X=X₀;

For i=1 to do;

If Sᵢ=abnormal, Tᵢ=Sᵢ;

End if;

End for;

If X≠X₀;

If P (fault phenomenon=abnormal|sensor in abnormal state=X)>0.3, sending the third-level risk early-warning according to the size of P;

P (component=abnormal|sensor in abnormal state=X);

Else if P (fault phenomenon=abnormal|sensor in abnormal state=X)>0.6, sending the second-level risk early-warning according to the size of P, P (component=abnormal|sensor in abnormal state=X);

Else if P (fault phenomenon=abnormal|sensor in abnormal state=X)>0.9, sending the first-level risk early-warning according to the size of P, P (component=abnormal|sensor in abnormal state=X);

End if;

End if;

End if;

End if.

To achieve the above-mentioned objective, the present disclosure further provides a troubleshooting fault component in equipment system.

The present disclosure provides the apparatus for troubleshooting fault component in equipment and the method thereof which are implemented by acquiring the data of the component in the abnormal state and the data of fault maintenance of the equipment, building the fault-component-sensor Bayesian belief network model according to the data, calculating the probabilities of actual component abnormality when the sensor connected with the component detects that the component is abnormal based on the fault-component-sensor Bayesian belief network model, arranging the probabilities of actual component abnormality when the sensor connected with the component detects that the component is abnormal in sequence in a descending order to obtain arranged probabilities of actual component abnormality, correspondingly arranging the components according to a sequence of the arranged probabilities of actual component abnormality, and the top-arranged component being the one to be troubleshot first. Namely, through the adoption of the apparatus or the method thereof provided by the present disclosure, a relational expression among the fault, the component and the sensor may be systematically built, and an component which is most likely to fail during occurrence of an equipment fault may be quickly detected according to the relational expression, thereby avoiding human subjective troubleshooting and improving the troubleshooting fault component in equipment efficiency.

In addition, the present disclosure judges whether the sensor is required to be added into or removed from the fault-component-sensor Bayesian belief network model according to the calculated probabilities of actual component abnormality when the sensor connected with the component detects that the component is abnormal and the probabilities of the set fault for equipment induced by the abnormalities of the component connected with the set fault for equipment, and updates the fault-component-sensor Bayesian belief network model according to the judgment results to improve the accuracy of the relational expression among the fault, the component and the sensor, thereby calculating the probabilities of actual component abnormality when the sensor connected with the component detects that the component is abnormal on the basis of the updated fault-component-sensor Bayesian belief network model to improve the troubleshooting fault component in equipment accuracy.

Therefore, through the adoption of the apparatus for troubleshooting fault component in equipment and the method thereof provided by the present disclosure, not only the troubleshooting fault component in equipment efficiency is improved, but also the troubleshooting fault component in equipment accuracy is improved.

All the embodiments in the description are described in a progressive manner. Each embodiment focuses on describing the differences from other embodiments. Same or similar parts of all the embodiments refer to each other. The system disclosed by one embodiment is relatively simply described as the system corresponds to the method disclosed by another embodiment, and related parts refer to part of the descriptions of the method.

The principle and implementation modes of the present disclosure are described by applying specific examples herein. The descriptions of the above embodiments are only configured to help to understand the method and the core idea of the present disclosure. Meanwhile, those ordinary skilled in the art can make changes to the specific implementation modes and the application scope according to the idea of the present disclosure. From the above, the contents of the description shall not be understood as limitations to the present disclosure.

What is claimed is:

1. An apparatus for troubleshooting a fault component in an equipment, comprising:
an acquiring portion for acquiring data of a component in an abnormal state and data of fault and maintenance of the equipment;
a building portion for building a fault-component-sensor Bayesian belief network model according to the data of the component in the abnormal state and data of fault and maintenance of the equipment; wherein the fault-component-sensor Bayesian belief network model comprises a sensor, a component and a set fault for the equipment; in the fault-component-sensor Bayesian belief network model, the sensor is connected with the component; the component is connected with the set fault for the equipment; the connection between the sensor and the component involves whether the component detected by the sensor is abnormal; and the connection between the component and the set fault for equipment involves that the set fault for equipment is induced by an abnormality of the component;
a calculating portion for calculating a plurality of probabilities of actual component abnormality detected by each of a plurality of sensors connecting with each of a plurality of components based on the fault-component-sensor Bayesian belief network model; and
a ranking portion for ranking the plurality of probabilities of actual component abnormality detected by the plurality of sensors connecting with each of the plurality of the components in a descending order, and to obtain ranked probabilities that the plurality of components are actually abnormal; the plurality of the components are ranked correspondingly according to the plurality of the probabilities of actual component abnormality ranked; and a top-ranked component is to be troubleshot first.

2. The apparatus of claim 1, wherein the building portion further comprises:
a constructing unit, configured to construct a table of sensor abnormality-component based on the data of the component in the abnormal state; wherein the table of sensor abnormality-component comprises a probability that a component is detected abnormal by the plurality of sensors and the component is actually abnormal; the data of the component in the abnormal state comprises a number of times that a component is detected abnormal by each of the plurality of sensors and the component is actually abnormal, a number of times that a component is detected normal by each of the plurality of sensors but the component is actually abnormal, and a number of times a component is detected normal by each of the plurality of sensors but the component is actually abnormal; wherein the probability that a component is detected abnormal by each of the plurality of sensors and the component is actually abnormal is represented by a ratio of a number of times a component is detected abnormal by each of the plurality of sensors and the component is actually abnormal, to a number of times of component abnormality; wherein the number of times of component abnormality is represented by a sum of the number of times that the component is detected abnormal by each of the plurality of sensors and the component is actually abnormal, the number of times that the component is detected normal by each of the plurality of sensors but the component is actually abnormal, and the number of times that the component is detected normal by each of the plurality of sensors but the component is actually abnormal;
a generating unit, configured to generate a fault dictionary based on the data of fault maintenance of the equipment; wherein the fault dictionary comprises a first probability of each of the plurality of components; the first probability is a probability of the set fault of the equipment when each of the plurality of components is abnormal; the data of fault maintenance of the equipment comprises a number of times of the set fault of the equipment when each of the plurality of the components is abnormal; wherein the first probability is further represented by a ratio of the number of times of set fault of the equipment when each of the plurality of the components is abnormal to the sum of the number of times of the set fault of the equipment when each of the plurality of the components is abnormal; and
a building unit, configured to build a fault-component-sensor Bayesian belief network model with a Bayesian belief network based on the fault dictionary and the table of sensor abnormality-component.

3. The apparatus of claim 1, wherein the calculating portion further comprises:
a calculating unit, configured to calculate the plurality of probabilities of actual component abnormality detected by the plurality of sensors connecting with each of the plurality of the components according to the following formula:
$$( 1 )$$
$$\{ \begin{matrix}\begin{matrix}{P}_{1} = ( {E}_{i} = abnormal \vert {S}_{i 1} = abnormal , & {S}_{i 2} = normal , … , & {S}_{im} = normal )\end{matrix} \\ \begin{matrix}{P}_{2} = ( {E}_{i} = abnormal \vert {S}_{i 1} = abnormal , & & {S}_{i 2} = abnormal , … , & {S}_{im} = normal )\end{matrix} \\ \begin{matrix} & ⋮ & & \\ {P}_{{2}^{m} - 1} = ( {E}_{i} = abnormal \vert {S}_{i 1} = normal , & & {S}_{i 2} = abnormal , … , & {S}_{im} = abnormal ) \\ {P}_{{2}^{m}} = ( {E}_{i} = abnormal \vert {S}_{i 1} = abnormal , & & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} ;$$
wherein Eᵢ represents the ith component; S represents the sensor; m represents the number of the sensors; and P_{Ei} represents the probabilities that component Eᵢ is detected abnormal by the plurality of sensors connecting with the component Eᵢ and the Eᵢ is actually abnormal.

4. The apparatus of claim 1, wherein the apparatus further comprises an operating portion, configured to correct and inquire a sequence of the plurality of the components ranked correspondingly according to the plurality of the probabilities of actual component abnormality.

5. The apparatus of claim 1, wherein the apparatus further comprises a display portion, configured to display the sequence of the plurality of the components ranked correspondingly according to the plurality of the probabilities of actual component abnormality.

6. The apparatus of claim 1, wherein the apparatus further comprises a sending portion, configured to send the sequence of the plurality of the components ranked correspondingly according to the plurality of the probabilities of actual component abnormality, to a terminal.

7. The apparatus of claim 1, wherein the apparatus further comprises a storage portion, configured to store the data of the component in the abnormal state, the data of fault maintenance of the equipment, the fault-component-sensor Bayesian belief network model, the sequence of the plurality of probabilities of actual component abnormality ranked and sequence of the plurality of the components ranked correspondingly according to the plurality of the probabilities of actual component abnormality.

8. A method for troubleshooting fault component in an equipment, comprising:
step 1: acquiring data of a component in an abnormal state and data of fault maintenance of the equipment;
step 2: building a fault-component-sensor Bayesian belief network model according to the data of the component in the abnormal state and data of fault maintenance of the equipment; wherein the fault-component-sensor Bayesian belief network model comprises a sensor, a component and a set fault for the equipment; in the fault-component-sensor Bayesian belief network model, the sensor is connected with the component; the component is connected with the set fault for the equipment; the connection between the sensor and the component involves whether the component detected the sensor is abnormal; and the connection between the component and the set fault for equipment involves that the set fault for equipment is induced by component abnormality;
step 3: calculating a plurality of probabilities of actual component abnormality detected by each of a plurality of sensors connecting with each of a plurality of components based on the fault-component-sensor Bayesian belief network model; and
step 4: ranking the plurality of probabilities of actual component abnormality detected by the plurality of sensors connecting with each of the plurality of the components in a descending order, and to obtain ranked probabilities that the plurality of components are actually abnormal; the plurality of the components are ranked correspondingly according to the plurality of the probabilities of actual component abnormality ranked; and a top-ranked component is to be troubleshot first.

9. The method of claim 8, wherein the step 2 further comprises: constructing a table of sensor abnormality-component based on the data of the component in the abnormal state; wherein the table of sensor abnormality-component comprises a probability that a component is detected abnormal by each of the plurality of sensors and the component is actually abnormal; the data of the component in the abnormal state comprises a number of times that a component is detected abnormal by each of the plurality of sensors and the component is actually abnormal, a number of times that a component is detected normal by each of the plurality of sensors but the component is actually abnormal, and a number of times a component is detected normal by each of the plurality of sensors but the component is actually abnormal; wherein the probability that a component is detected abnormal by each of the plurality of sensors and the component is actually abnormal is represented by a ratio of a number of times a component is detected abnormal by each of the plurality of sensors and the component is actually abnormal, to a number of times of component abnormality; wherein the number of times of component abnormality is represented by a sum of the number of times that the component is detected abnormal by each of the plurality of sensors and the component is actually abnormal, the number of times that the component is detected normal by each of the plurality of sensors but the component is actually abnormal, and the number of times that the component is detected normal by each of the plurality of sensors but the component is actually abnormal;
generating a fault dictionary based on the data of fault maintenance of the equipment; wherein the fault dictionary comprises a first probability of each of the plurality of components; the first probability is a probability of the set fault of the equipment when each of the plurality of components is abnormal; the data of fault maintenance of the equipment comprises a number of times of the set fault of the equipment when each of the plurality of the components is abnormal; wherein the first probability is further represented by a ratio of the number of times of set fault of the equipment when each of the plurality of the components is abnormal to the sum of the number of times of the set fault of the equipment when each of the plurality of the components is abnormal; and
building a fault-component-sensor Bayesian belief network model with a Bayesian belief network based on the fault dictionary and the table of sensor abnormality-component.

10. The method of claim 8, wherein the step 3 further comprises:
calculating the plurality of probabilities of actual component abnormality detected by the plurality of sensors connecting with each of the plurality of the components according to the following formula 1:
$$\begin{matrix}\{ \begin{matrix}\begin{matrix}{P}_{1} = ( {E}_{i} = abnormal \vert {S}_{i 1} = abnormal , & {S}_{i 2} = normal , … , & {S}_{im} = normal )\end{matrix} \\ \begin{matrix}{P}_{2} = ( {E}_{i} = abnormal \vert & {S}_{i 1} = abnormal , & {S}_{i 2} = abnormal , … , & {S}_{im} = normal )\end{matrix} \\ \begin{matrix} & … & & \\ & … & & \\ & … & & \\ {P}_{{2}^{m} - 1} = ( {E}_{i} = abnormal \vert & {S}_{i 1} = normal , & {S}_{i 2} = abnormal , … , & {S}_{im} = abnormal ) \\ {P}_{{2}^{m}} = ( {E}_{i} = abnormal \vert & {S}_{i 1} = abnormal , & {S}_{i 2} = abnormal , … , & {S}_{im} = abnormal ) \\ {P}_{Ei} = {P}_{1} + {P}_{2} + … + {P}_{{2}^{m}} & & & \end{matrix}\end{matrix} & ( 1 )\end{matrix}$$
where Eᵢ represents the ith component; S represents the sensor; m represents the number of the sensors; P_{Ei} represents the probabilities that component Eᵢ is detected abnormal by the plurality of sensors connecting with the component Eᵢ and the Eᵢ is actually abnormal.

11. The method of claim 8, wherein the method further comprises:
calculating a probability of a set fault of the equipment induced by abnormality of the component connected with the set fault of the equipment, based on the fault-component-sensor Bayesian belief network model and formula 2, wherein the formula 2 is as follows:
$$\begin{matrix}\begin{matrix}\{ \begin{matrix}\begin{matrix}{P}_{1} = ( {F}_{j} = abnormal \vert {E}_{j 1} = abnormal , & {E}_{j 2} = normal , … , & {E}_{jn} = normal )\end{matrix} \\ \begin{matrix}{P}_{2} = ( {F}_{j} = abnormal \vert & {E}_{j 1} = abnormal , & {E}_{j 2} = abnormal , … , & {E}_{jn} = normal )\end{matrix} \\ \begin{matrix} & ⋮ & & \\ {P}_{{2}^{n} - 1} = ( {F}_{j} = abnormal \vert & {E}_{j 1} = normal , & {E}_{j 2} = abnormal , … , & {E}_{jn} = abnormal )\end{matrix}\end{matrix} & \end{matrix} & ( 2 ) \\ \begin{matrix}{P}_{{2}^{n}} = ( {F}_{j} = abnormal \vert & {E}_{j 1} = abnormal , & {E}_{j 2} = abnormal , … , & {E}_{jn} = abnormal ) \\ {P}_{Fj} = {P}_{1} + {P}_{2} + … + {P}_{{2}^{n}} & & & \end{matrix} & \end{matrix}$$
where Fⱼ represents the jth fault; E represents the component; n represents the number of the components; and P_{Fj} represents the probability of the set fault for equipment Fⱼ induced by the abnormalities of the n component connected with the set fault for equipment Fⱼ.

12. The method of claim 9, wherein before the step 4, the method further comprises:
judging whether the first probability of an component is greater than a first threshold value and whether the component is connected with each of the plurality of the sensor, obtaining a first judgment result;
connecting each of the plurality of sensors with the component, if the first judgment result shows that the first probability of the component is greater than the first threshold value and the component is not connected with each of the plurality of sensors;
maintaining connection between the component and the plurality of sensors, if the first judgment result shows that the first probability of the component is no larger than the first threshold value or the component is connected with the plurality of sensors;
updating the fault-component-sensor Bayesian belief network model based on the first judgment result; and
calculating the actual probability of component abnormality when the component is detected abnormal by the plurality of the sensor connecting to the component based on the updated fault-component-sensor Bayesian belief network model.

13. The method of claim 12, wherein the step of updating the fault-component-sensor Bayesian belief network model according to the first judgment result further comprises:
judging whether the probability that a component is detected abnormal by each of the plurality of sensors and the component is actually abnormal is no smaller than a second threshold value, obtaining a second judgment result;
reserving the sensor if the second judgment result shows that the probability that a component is detected abnormal by each of the plurality of sensors connecting to the component and the component is actually abnormal is no smaller than the second threshold value;
judging whether the probability that a component is detected abnormal by each of the plurality of sensors connecting to the component and the component is actually abnormal is no smaller than a third threshold value, if the second judgment result shows the probability is less than the second threshold value when the component is detected abnormal, and obtaining a third judgment result; wherein the third threshold value is represented by a setting number of times of the probability when the plurality of sensors connected with the component except for the sensor detected that the component is abnormal and the component is actually abnormal;
reserving the sensor if the third judgment result shows that the probability that the component is actually abnormal when the sensor connected with the component detects that the component is in the abnormal state is no smaller than the third threshold value;
removing the sensor if the third judgment result shows that the actual probability of component abnormality is less than the third threshold value when the component is detected abnormal by the sensor; and
updating the fault-component-sensor Bayesian belief network model according to the first judgment result, the second judgment result and the third judgment result.

14. The method of claim 13, wherein the method further comprises:
calculating the probabilities of the set fault for the equipment induced by the abnormality of the component connected with the updated equipment set fault according to the updated fault-component-sensor Bayesian belief network model; and
building an equipment risk early-warning database according to the calculated probabilities of the set fault for equipment induced by the abnormality of the component connected with the updated set fault for the equipment.
